(19) United States
(12) Patent Application Publication
(10) Pub. No.: US 2019/0316757 A1
(43) Pub. Date: Oct. 17, 2019

(54) SECONDARY LIGHT DISTRIBUTION STRUCTURE OF DIRECTIONAL LIGHT SOURCE

(71) Applicant: NINGBO YAMAO OPTOELECTRONICS CO., LTD., Xikou Ningbo (CN)

(72) Inventor: Hui CHEN, Xikou Ningbo (CN)

(21) Appl. No.: 16/123,617

(22) Filed: Sep. 6, 2018

(30) Foreign Application Priority Data
Apr. 11, 2018 (CN) 201820510278.7

(51) Int. Cl. F21V 13/04; F21V 7/06; F21V 23/02; F21V 5/04

(52) U.S. Cl. CPC F21V 13/04; F21V 5/04; F21V 23/02; F21V 7/06

(57) ABSTRACT

The present invention discloses a secondary light distribution structure of a directional light source comprises a lamp cup having a cone shape, wherein the lamp cup is provided with a lamp cap at an end having a smaller diameter, and the lamp cap is connected with the lamp cup; a reflective cup disposed in the lamp cup, an outer wall of the reflective cup fits into an inner wall of the lamp cup, an inner wall of the reflective cup is coated with a reflective layer, and a light source plate is attached to a bottom of the reflective cup; a power supply disposed between the reflective cup and the lamp cap, one end of the power supply is connected to the lamp cap, the other end of the power supply passes through the bottom of the reflective cup and is connected to the light source plate; and a lens structure fixed at the end of the lamp cup having a larger diameter. The invention has a reflector to have higher light distribution efficiency through a secondary light distribution structure, so as to obtain a desired light distribution.

### BACKGROUND OF THE INVENTION

### 1. Field of the Invention

The invention relates to the technical field of a directional light source, and more particularly, to a light distribution structure of the directional light source.

### 2. Description of the Related Art

Generally, after a directional light source of an LED is subjected to light distribution, light in its beam angle is unevenly distributed. In particular, it is observed that the central light intensity is high, and a stepped drop is obvious. In addition, yellow spots and black dots can be found on the illuminated object, and stray light is emitted outside the beam angle.

When replacing the original traditional light source, the directional light source must be matched to the light distribution curve of the product in use, thus, requirements for light environment can be met.

### SUMMARY OF THE INVENTION

Given that the foregoing problems exist in the prior art, the present invention provides a secondary light distribution structure of a directional light source.

In order to achieve the above purposes, the present invention adopts the following technical solutions.

A secondary light distribution structure of a directional light source comprises a lamp cup having a cone shape, wherein the lamp cup is provided with a lamp cap at an end having a smaller diameter, and the lamp cap is connected with the lamp cup; a reflective cup disposed in the lamp cup, an outer wall of the reflective cup fits into an inner wall of the lamp cup, an inner wall of the reflective cup is coated with a reflective layer, and a light source plate is attached to a bottom of the reflective cup; a power supply disposed between the reflective cup and the lamp cap, one end of the power supply is connected to the lamp cap, the other end of the power supply passes through the bottom of the reflective cup and is connected to the light source plate; and a lens structure fixed at the end of the lamp cup having a larger diameter.

In the secondary light distribution structure of the directional light source, wherein the lens structure comprises a multi-point lens, which is fixed at one end of the lamp cup having a larger diameter.

In the secondary light distribution structure of the directional light source, wherein one side of the multi-point lens facing the light source plate is a bead surface, and the other side of the multi-point lens facing away from the light source plate is a smooth surface.

In the secondary light distribution structure of the directional light source, the lens structure comprises a lens fixedly connected to the bottom of the reflective cup, the lens directly facing the light source plate; a planar lens fixed at one end of the lamp cup having a larger diameter.

In the secondary light distribution structure of the directional light source, wherein the lens is fixedly connected to the bottom of the reflective cup by glue, mechanical curling and a buckle.

In the secondary light distribution structure of the directional light source, wherein the inner wall of the reflective cup is a parabolic structure.

By adopting the aforementioned technical solutions, the present invention has the following advantageous effects when compared with the prior art, that is, the use of the secondary light distribution structure and the reflector makes it possible for the present invention to have higher light distribution efficiency, and to obtain a desired light distribution.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a schematic view of a secondary light distribution structure of a directional light source according to the present invention.

FIG. 2 is a cross-sectional view showing a secondary light distribution structure of a directional light source according to the present invention.

FIG. 3 is the first type of schematic view of a secondary light distribution structure of a directional light source according to the present invention.

FIG. 4 is the second type of schematic view of a secondary light distribution structure of a directional light source according to the present invention.

### LIST OF REFERENCE NUMERALS

1. Lamp cup

2. Lamp cap

3. Reflective cup

4. Light source plate

5. Power supply

61. Multi-point lens

62. Lens

63. Planar lens

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “plurality” means a number greater than one.

Hereinafter, certain exemplary embodiments according to the present disclosure will be described with reference to the accompanying drawings.

### First Embodiment

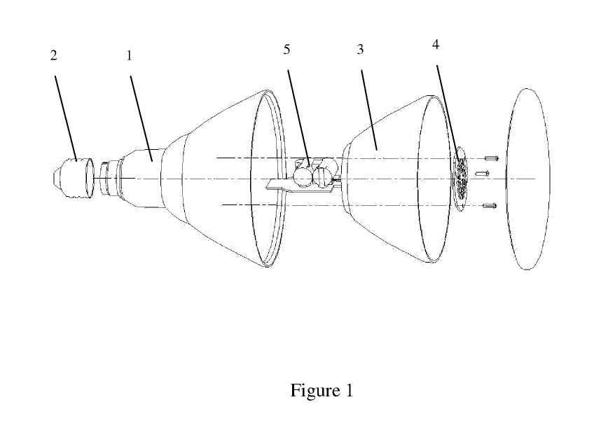

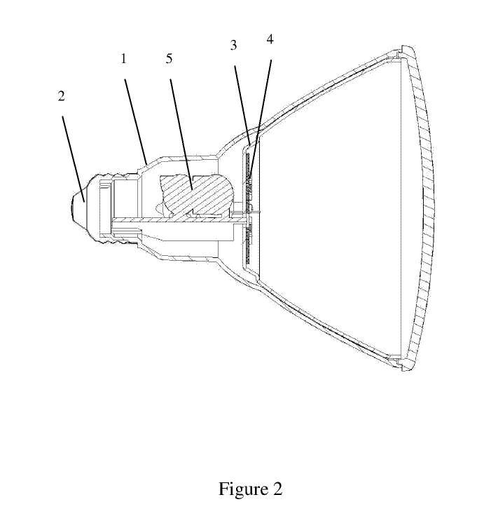

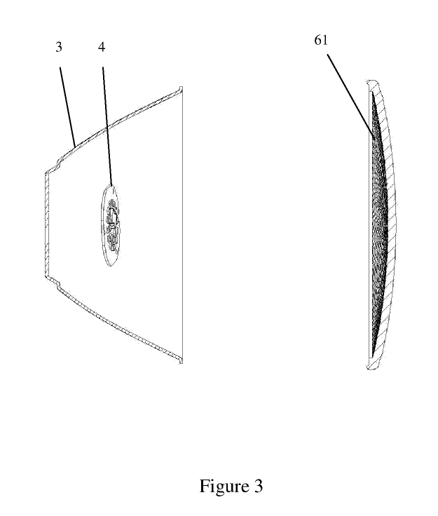

FIG. 1 is a schematic view of a secondary light distribution structure of a directional light source according to the present invention, FIG. 2 is a cross-sectional view showing a secondary light distribution structure of a directional light source according to the present invention, and FIG. 3 is the first schematic view of a secondary light distribution structure of a directional light source according to the present invention. Referring now to FIGS. 1-3, a secondary light distribution structure of a directional light source in the first preferred embodiment is shown, the secondary light distribution structure of the directional light source comprises a lamp cup 1 having a cone shape, wherein the lamp cup 1 is provided with a lamp cap 2 at an end having a smaller diameter, and the lamp cap 2 is connected with the lamp cup 1.

Furthermore, the secondary light distribution structure of the directional light source in a preferred embodiment further comprises a reflective cup 3 disposed in the lamp cup 1, an outer wall of the reflective cup 3 fits into an inner wall of the lamp cup 1, an inner wall of the reflective cup 3 is coated with a reflective layer, and a light source plate 4 is attached to a bottom of the reflective cup 3. The first light distribution is performed through the reflective cup 3.

In addition, the secondary light distribution structure of the directional light source in a preferred embodiment further comprises a power supply 5 disposed between the reflective cup 3 and the lamp cap 2, one end of the power supply 5 is connected to the lamp cap 2, the other end of the power supply 5 passes through the bottom of the reflective cup Sand is connected to the light source plate 4.

Furthermore, the secondary light distribution structure of the directional light source in a preferred embodiment further comprises a lens structure fixed at the end of the lamp cup 1 having a larger diameter. The second light distribution is performed through the lens structure.

Furthermore, the lens structure in a preferred embodiment comprises a multi-point lens 61, which is fixed at one end of the lamp cup 1 having a larger diameter. The second light distribution is performed through the multi-point lens 61.

Furthermore, in a preferred embodiment, one side of the multi-point lens 61 facing the light source plate 4 is a bead surface, and the other side of the multi-point lens 61 facing away from the light source plate 4 is a smooth surface. The multi-point lens 61 consists of a plurality of small lenses and the second light distribution is performed through the multi-point lens 61. In this manner, light in the effective beam angle may be evenly distributed and obvious light gradient no longer exists, and yellow spots and black dots may not be present on the illuminated object.

The foregoing description is only a preferred embodiment of the present invention, not thus limiting the embodiments and scope of the invention.

The invention further has the following implementation based on the abovementioned embodiment. Specifically, in a further embodiment of the invention, referring again to FIGS. 1-3, the inner wall of the reflective cup 3 is a paraboloid structure.

### Second Embodiment

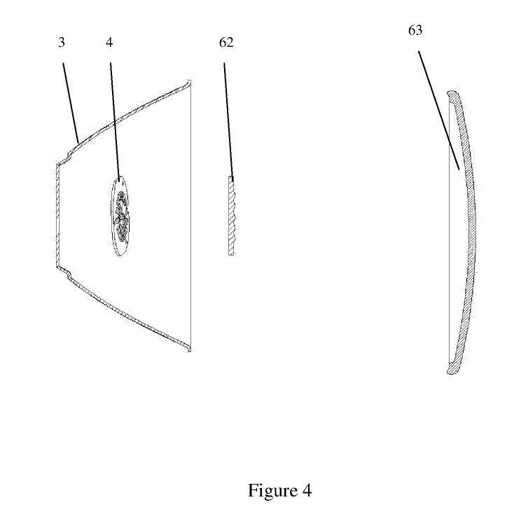

FIG. 1 is a schematic view of a secondary light distribution structure of a directional light source according to the present invention, FIG. 2 is a cross-sectional view showing a secondary light distribution structure of a directional light source according to the present invention, and FIG. 4 is the second type of schematic view of a secondary light distribution structure of a directional light source according to the present invention. Referring now to FIGS. 1, 2 and 4, a secondary light distribution structure of a directional light source in the second preferred embodiment is shown, the secondary light distribution structure of the directional light source comprises a lamp cup 1 having a cone shape, wherein the lamp cup 1 is provided with a lamp cap 2 at an end having a smaller diameter, and the lamp cap 2 is connected with the lamp cup 1.

Furthermore, the secondary light distribution structure of the directional light source in a preferred embodiment further comprises a reflective cup 3 disposed in the lamp cup 1, an outer wall of the reflective cup 3 fits into an inner wall of the lamp cup 1, an inner wall of the reflective cup 3 is coated with a reflective layer, and a light source plate 4 is attached to a bottom of the reflective cup 3. The first light distribution is performed through the reflective cup 3.

In addition, the secondary light distribution structure of the directional light source in a preferred embodiment further comprises a power supply 5 disposed between the reflective cup 3 and the lamp cap 2, one end of the power supply 5 is connected to the lamp cap 2, the other end of the power supply 5 passes through the bottom of the reflective cup Sand is connected to the light source plate 4.

Furthermore, the secondary light distribution structure of the directional light source in a preferred embodiment further comprises a lens structure, fixed at the end of the lamp cup 1 having a larger diameter. The second light distribution is performed through the lens structure.

Furthermore, the lens structure in a preferred embodiment comprises a lens 62 fixedly connected to the bottom of the reflective cup 3, the lens 62 directly facing the light source plate 4. The second light distribution is performed through the lens 62.

Furthermore, the planar lens 63 in a preferred embodiment is fixed at one end of the lamp cup 1 having a larger diameter. The planar lens 63 serves as a protective cover for the lamp, and the planar lens 63 may directly exhibit the light-emitting performance after the reflective cup 3 being distributed the light.

The foregoing description is only a preferred embodiment of the present invention, not thus limiting the embodiments and scope of the invention.

The invention further has the following implementation based on the abovementioned embodiment. Specifically, in a further embodiment of the invention, referring again to FIGS. 1, 2 and 4, the lens 62 is fixedly connected to the bottom of the reflective cup 3 by glue, mechanical curling and a buckle.

In a further embodiment of the present invention, the inner wall of the reflective cup 3 is a parabolic structure.

The above descriptions are only the preferred embodiments of the invention, not thus limiting the embodiments and scope of the invention. Those skilled in the art should be able to realize that the schemes obtained from the content of specification and drawings of the invention are within the scope of the invention. In the present invention, the use of the secondary light distribution structure and the reflector makes it possible for the present invention to have higher light distribution efficiency, and to obtain a desired light distribution.

What is claimed is:

1. A secondary light distribution structure of a directional light source, comprising:
a lamp cup having a cone shape, the lamp cup being provided with a lamp cap at an end having a smaller diameter, and the lamp cap being connected with the lamp cup;
a reflective cup disposed in the lamp cup, an outer wall of the reflective cup fitting into an inner wall of the lamp cup, an inner wall of the reflective cup being coated with a reflective layer, and a light source plate being attached to a bottom of the reflective cup;
a power supply disposed between the reflective cup and the lamp cap, one end of the power supply being connected to the lamp cap, the other end of the power supply passing through the bottom of the reflective cup and being connected to the light source plate; and
a lens structure fixed at the end of the lamp cup having a larger diameter.

2. The secondary light distribution structure of the directional light source as claimed in claim 1, wherein the lens structure comprises:
a multi-point lens fixed at one end of the lamp cup having a larger diameter.

3. The secondary light distribution structure of the directional light source as claimed in claim 2, wherein one side of the multi-point lens facing the light source plate is a bead surface, and the other side of the multi-point lens facing away from the light source plate is a smooth surface.

4. The secondary light distribution structure of the directional light source as claimed in claim 1, wherein the lens structure comprises:
a lens fixedly connected to the bottom of the reflective cup, the lens directly facing the light source plate;
a planar lens fixed at one end of the lamp cup having a larger diameter.

5. The secondary light distribution structure of the directional light source as claimed in claim 4, wherein the lens is fixedly connected to the bottom of the reflective cup by glue, mechanical curling and a buckle.

6. The secondary light distribution structure of the directional light source as claimed in claim 1, wherein the inner wall of the reflective cup is a parabolic structure.
